(19) United States
(12) Patent Application Publication
(10) Pub. No.: US 2007/0143755 A1
(43) Pub. Date: Jun. 21, 2007

(54) Speculative execution past a barrier

(75) Inventors: Bratin Sahu, San Jose, CA (US); Ali-Reza Adl-Tabatabai, Santa Clara, CA (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/305,506

(22) Filed: Dec. 16, 2005

(51) Int. Cl. G06F 9/46

(52) U.S. Cl. 718/100

(57) ABSTRACT

In a multi-threaded program, a thread, of a set of threads sharing a synchronization barrier, indicating that the thread has reached the synchronization barrier to each other thread of the set of threads, the thread beginning a transactional memory based transaction after the indicating, and the thread continuing execution past the synchronization barrier after beginning the transactional memory based transaction.

### CROSS-REFERENCE TO RELATED APPLICATION

The present application is related to pending U.S. patent application Ser. No. ______ entitled “LOCK ELISION WITH TRANSACTIONAL MEMORY,” Attorney Docket Number P22226, and assigned to the assignee of the present invention.

### BACKGROUND

Transactional support in hardware for lock-free shared data structures using transactional memory is described in M. Herlihy and J. Moss, Transactional memory: Architectural support for lock-free data structures, Proceedings of the 20^{th} Annual International Symposium on Computer Architecture 20, 1993 (Herlihy and Moss). This approach describes a set of extensions to existing multiprocessor cache coherence protocols that enable such lock free access. Transactions using a transactional memory are referred to as transactional memory transactions or lock free transactions herein.

Barrier synchronization is a commonly used paradigm in multi-thread programming, such as for example in the OpenMP system. Barrier synchronization may also be used in other widely used concurrent programming systems including systems based on threads implemented in pthreads or Java. In general a barrier in a concurrent computation is a synchronization point shared by multiple threads or processes. For multiple threads to correctly execute past a barrier it is sufficient that each thread verifies that all other threads executing concurrently have reached the barrier. Typically, when all threads that are in the set of threads that use the barrier have reached the barrier, some predicate that is a prerequisite for continued correct execution of the multithreaded program is guaranteed to be true, and thus program execution can continue in all threads. In general, a synchronization variable, often incorporating a counter, is used by threads to communicate to each other that they have reached a barrier. Mutually exclusive access to the barrier variable thus may force a serialization point at the barrier in a typical implementation, and a suspension of useful execution of each thread that has reached the barrier until all threads reach the barrier, thus potentially lowering performance. However, because all threads reaching the barrier is a sufficient but not a necessary condition for correct execution of any other thread past the barrier, it may be possible in some instances for threads to correctly execute past the barrier even if all threads have not yet reached the barrier.

Academic approaches involving programmer modification of multi-threaded programs and specialized hardware have been suggested as a way to increase the performance of barrier synchronization. See for example, Rajiv Gupta. The fuzzy barrier: A mechanism for high speed synchronization of processors. In Proceedings of the Third International Conference on Architectural Support for Programming Languages and Operating Systems (ASPLOS III), pages 54-63, Boston, Mass., Apr. 3-6, 1989. ACM Press.

### BRIEF DESCRIPTION OF THE DRAWINGS

FIG. 1 depicts a processor based system in one embodiment.

FIG. 2 depicts processing in one embodiment.

### DETAILED DESCRIPTION

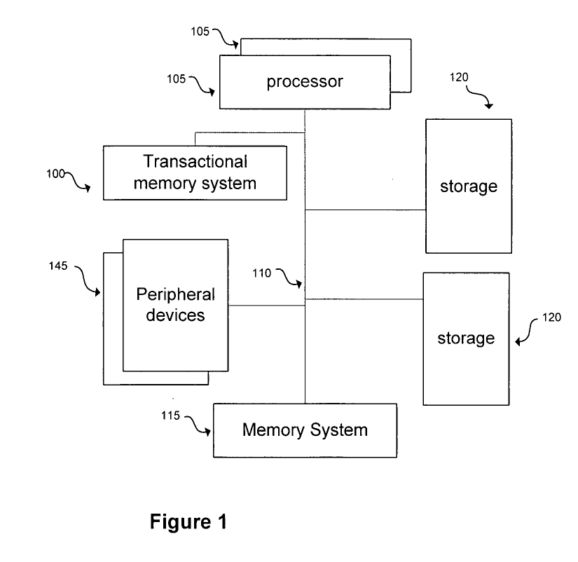

FIG. 1 depicts a processor based system that may include one or more processors 105 coupled to a bus 110. Alternatively the system may have a processor that is a multi-core processor, or in other instances, multiple multi-core processors. In a simple example, the bus 110 may be coupled to system memory 115, storage devices such as disk drives or other storage devices 120, peripheral devices 145. The storage 120 may store various software or data. The system may be connected to a variety of peripheral devices 145 via one or more bus systems. Such peripheral devices may include displays and printing systems among many others as is known.

In one embodiment, a processor system such as that depicted in the figure adds a transactional memory system 100 that allows for the execution of lock free transactions with shared data structures cached in the transactional memory system, as described in Herlihy and Moss. The processor(s) 105 may then include an instruction set architecture that supports such lock free or transactional memory based transactions. In such an architecture, the system in this embodiment supports a set of instructions, including an instruction to begin a transaction; an instruction to commit and terminate a transaction normally; and an instruction to abort a transaction. Within a transaction all memory locations are accessed speculatively, and all memory updates are buffered. During a transaction a cache coherence protocol indicates whether another thread is trying to access the same memory locations. If any conflicts are detected, an interrupt is generated that may be handled by an abort handler. On commit the speculative updates become visible atomically. Transactional execution may also be terminated due to other reasons such as oversubscription of hardware resources, and other exceptions.

The system of FIG. 1 is only an example and the present invention is not limited to any particular architecture. Variations on the specific components of the systems of other architectures may include the inclusion of transactional memory as a component of a processor or processors of the system in some instances; in others, it may be a separate component on a bus connected to the processor. In other embodiments, the system may have additional instructions to manage lock free transactions. The actual form or format of the instructions in other embodiments may vary. Additional memory or storage components may be present. A large number of other variations are possible.

In a typical multi-threaded program, a code sequence like that shown below in Table 1 may be used to implement barrier synchronization.

TABLE 1
Copyright © 2005 Intel Corporation

| | |
|---|---|
| 1 | void barrierWait(Barrier* barrierObject) |
| 2 | { |

| | |
|---|---|
| 3 | lockedInc barrierObject−>numberThreadsAtBarrier; |

| | |
|---|---|
| 4 | /* barrier increment */ |
| 5 | |

| | |
|---|---|
| 6 | while ( |

| | |
|---|---|
| 7 | barrierObject−>numberThreadsAtBarrier != |
| 8 | barrierObject−>numberThreadsInTeam); |

| | |
|---|---|
| 9 | /* barrier check spinlock*/ |

| | |
|---|---|
| 10 | } |

In the code sequence in Table 1, the operation lockedInc is a mutually exclusive increment operation that increments the field numberThreadsAtBarrier of the variable barrierObject which is a barrier synchronization variable shared by all threads, initially set to zero. Furthermore, the value of the field numberThreadsInTeam of the barrier variable is the number of threads in the multi-threaded computation. As may be seen from the code sequence above, each thread arriving at the barrier first increments the barrier variable, and then waits in a spin lock loop at lines 6 through 8, until all threads have reached the barrier. This is indicated by the condition: barrierObject->numberThreadsAtBarrier!=barrierObject->numberThreadsInTeam becoming true, which is when every thread that is in the computation, has incremented the field numberThreadsAtBarrier and thus indicated that it has reached the barrier.

The code sequence in Table 1 represents barrier synchronization, as typically implemented. As is well-known, such synchronization is expensive, because every thread needs to access the shared barrier variable, barrierObject, which must be accessed sequentially at least for increment, and moreover because each thread must sit and spin in a spin lock loop until all other threads have incremented the barrier variable.

In an out of order machine, the processor may internally speculate past the check in barrierWait and execute program instructions speculatively following the barrier. During such speculation, the processor also ensures consistency; that is it makes sure no other processor or thread is accessing the same data that it has accessed. However, if all threads have not reached the barrier the speculation will trigger a branch mis-prediction exception in the out of order processor, causing all the speculative work to be discarded, and the processor will revert to spinning in the spinlock loop.

In one embodiment, a processor based system that supports transactional memory in hardware may be used to speculatively execute past a barrier using properties of instruction set architecture support for transactional memory. This enables speculative execution past a synchronization barrier in processors that do not have support for out of order execution. Even in processors that have support for out of order execution, this allows speculative execution of a multithreaded program past a barrier, without the risk of the out of order processor speculation being discarded as described above.

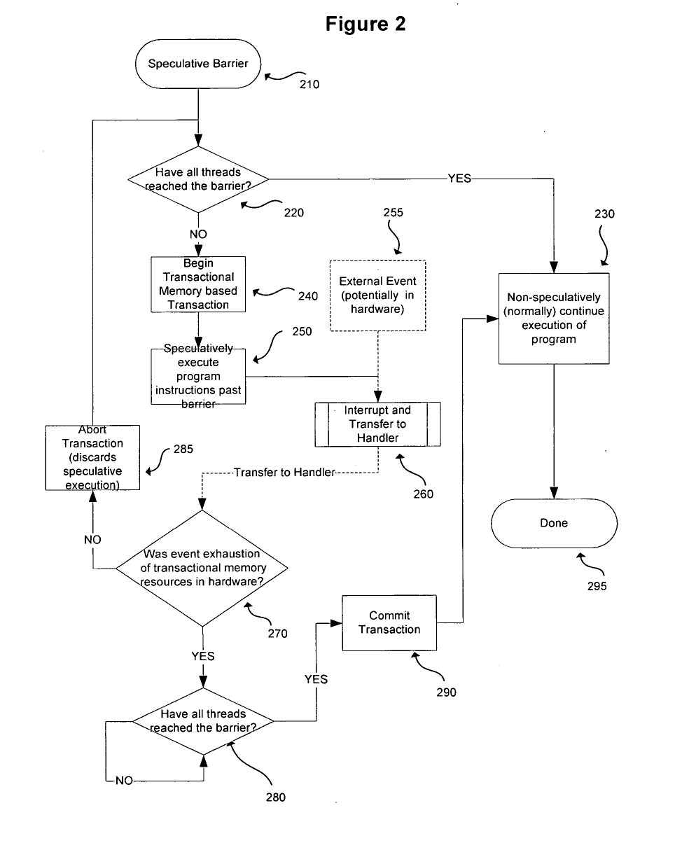

FIG. 2 describes processing in one such embodiment. In the figure, the processing implements a speculative barrier based on transactional memory, starting at 210. The multithreaded program first checks, at 220, if all threads have reached the barrier, for example by checking a barrier synchronization variable. Because this action is a read action, it need not be mutually exclusive. If all threads have already reached the barrier, there is no need for speculative execution and normal execution may continue at 230 until it terminates at 295.

However, if all threads have not yet reached the barrier, the program proceeds to, begin a speculative execution, past the barrier, for this thread. In order to ensure that the speculative execution is protected from interference by other threads, the program invokes the instruction to begin a transactional memory based transaction provided by the architecture at 240. It then speculatively executes the remaining portion of the program, 250 until it is interrupted by an external event that requires the attention of the transaction abort handler at 255. This external event in one case is the exhaustion of hardware resources devoted to speculative execution in the transactional memory system. Because only a finite amount of hardware is available for transactional memory support and thus for speculative execution, this interrupt will eventually be generated. As discussed above, it is also possible in other cases that this interrupt is generated due to a data error in speculation, such as interference between threads that has caused the speculative execution to be compromised. In each case, the interrupt transfers control to the abort handler at 260. It should be noted that the interrupt merely transfers control to the handler and there is neither an abort and roll back, or a commit of the transaction at this point. The abort handler then takes over at 270. First, the handler determines the cause of the interrupt that invoked it. If the interrupting event was only the exhaustion of hardware resources dedicated to transactional memory, then no error that affects the correctness of the speculative computation has yet occurred. Next, at 280 the handler checks if all threads have reached the barrier by reading the synchronization variable. If there are still threads that have not arrived at the barrier, the thread must wait in a spinlock loop at 280 because at this point either hardware resources for speculation may no longer be available, or a speculation related error may have occurred: that is, no further speculation is possible in any case. Once all threads have arrived at the barrier, the transaction may then be committed at 290, and normal execution may continue at 230. At this point all previously speculative execution is no longer speculative, that is it becomes effective and its side effects visible to all other threads. In the alternative case, at 270, it may turn out that the abort handler was invoked due to an event created by an actual error in speculation, such as an attempt by a different thread to write a variable that has already been read by this thread. In this case, the speculation needs to be rolled back. This is done by aborting the transaction at 285 and returning to the beginning of the process at 220. The abort discards all speculative execution, because no commit action has occurred. Of course, the thread may retry a speculative execution once again at this point.

It should be noted that while the abort handler is waiting in the loop at 280, other data conflicts may occur. This would then lead to a re-entrant invocation of the handler at 270. If the re-entrant invocation is caused by a mis-speculation the handler will operate as above and cause a rollback of the speculation.

Eventually either a speculative execution or a conventional execution will succeed and normal execution past the barrier at 230 will be reached.

It should be clear that the processing depicted in FIG. 2 is merely that of one embodiment. Other embodiments may differ. Specific terms, for example, may differ in descriptions of other embodiments: the term thread may be replaced by “process,” the term program, by “computation,” the term “interrupt” by “trap” among many others as is known in the art. The flow of control depicted may be varied to obtain equivalent programs flows by an artisan in other embodiments. Many such variations are possible.

Tables 1 and 2 list pseudocode used to implement speculative barriers as generally described above.

TABLE 2
Copyright © 2005 Intel Corporation

| | |
|---|---|
| 1 | void SpeculativeBarrierWait(Barrier* barrier) |
| 2 | { |

| | |
|---|---|
| 3 | if (getAtomicDepth( ) != 0) { |

| | |
|---|---|
| 4 | exit(1); |

| | |
|---|---|
| 5 | } |
| 6 | |

| | |
|---|---|
| 7 | if (getSpeculativeBarrierDepth( ) == True) { |

| | |
|---|---|
| 8 | myEpoch = barrier−>epoch; |
| 9 | oldValue = non_transactional ( |

| | |
|---|---|
| 10 | lockedXadd(barrier−>numThreadsLeftToEnter, −1)); |

| | |
|---|---|
| 11 | if (oldValue != 1) { |

| | |
|---|---|
| 12 | while (myEpoch == barrier−>epoch); |

| | |
|---|---|
| 13 | return; |
| 14 | } |
| 15 | else { |

| 16 | barrier−>numThreadsLeftToEnter = |
|---|---|
| | barrier−>numThreadsInTeam; |
| 17 | barrier−>epoch++; |
| 18 | return; |

| | |
|---|---|
| 19 | } |

| | |
|---|---|
| 20 | } |
| 21 | myEpoch = barrier−>epoch; |
| 22 | oldValue = lockedXadd(barrier−>numThreadsLeftToEnter, −1); |
| 23 | if (oldValue != 1) { |

| | |
|---|---|
| 24 | if (BeginTransaction ( ) == TransactionStarted) { |

| | |
|---|---|
| 25 | setSpeculativeBarrierDepth(True); |
| 26 | setSpeculativeBarrier(barrier); |
| 27 | setSpeculativeEpoch(myEpoch); |
| 28 | return; |

| | |
|---|---|
| 29 | } |
| 30 | else { |

| | |
|---|---|
| 31 | while (myEpoch == barrier−>epoch); |
| 32 | return; |

| | |
|---|---|
| 33 | } |

| | |
|---|---|
| 34 | } |
| 35 | else { |

| 36 | barrier−>numThreadsLeftToEnter = |
|---|---|
| | barrier−>numThreadsInTeam; |
| 37 | barrier−>epoch++; |
| 38 | return; |

| | |
|---|---|
| 39 | } |

| | |
|---|---|
| 40 | } |

TABLE 3

| | |
|---|---|
| 1 | int SpeculativeBarrierAbortHandler( ) |
| 2 | { |

| | |
|---|---|
| 3 | if (TRSR.failureReason != HWResourceOverflow) { |

| | |
|---|---|
| 4 | abort_transaction; |

| | |
|---|---|
| 5 | } |
| 6 | barrier = getSpeculativeBarrier( ); |
| 7 | epoch = getSpeculativeEpoch( ); |
| 8 | while (epoch == barrier−>epoch); |
| 9 | commit_transaction; |
| 10 | return; |

| | |
|---|---|
| 11 | } |

In Table 2, pseudocode to further clarify processing by a multithreaded program in one embodiment is shown. The code first checks at lines 3-4 if it is already inside some other critical section, and aborts, exiting at line 4, if that is the case. This is because a barrier should generally not occur inside any existing atomic region. At line 7, the court checks if this program has already speculated past a previously encountered barrier in which case the function call getSpeculativeBarrierDepth would return the value true. In this particular case, further speculative execution is not possible, and therefore the code at lines 8 through 18 generally performs a traditional barrier variable test and spinlock loop and waits on the barrier. In this code, a specific type of barrier synchronization variable known in the art and called an epoch synchronization variable is used. Specifically, at line 10, non-transactional code first checks if other threads are left to enter. If that is so the spinlock loop at line 12 executes until the barrier is available. If at line 10, the code detects that it is the last thread to enter the barrier then it is done with its barrier wait and can proceed.

If however, the code at line 7 finds that it has not previously speculated past an encountered barrier, then the transactional phase of the code can begin. It may be noted that the code at lines 21 through 38 in Table 2 corresponds generally to blocks 220-260 from FIG. 2. As in the non-transactional case, the code at line 23 first checks to see if other threads are left to enter the barrier. If there are such threads, then a speculative transaction begins. The BeginTransaction call at line 24 is a wrapper for an instruction provided by the transactional memory architecture underlying this implementation. In this embodiment, the BeginTransaction call yields a specific code TransactionStarted if it succeeds. If the transaction has been correctly begun, the code stores information about this barrier in a memory location that is local to the executing thread, otherwise known in the literature as thread local storage (TLS). Specifically at lines 25 through 27, the code stores the fact that this particular thread has speculated past the barrier, a reference to the barrier variable, and a reference to the epoch to check if all threads have hit the barrier. It then returns at line 28, which means that the thread can now continue to execute speculatively until an abort occurs. On the other hand, at line 22, this function may find that it is the last thread to attempt to enter the barrier. Thus no speculative execution is necessary and the code may just return as in the normal, nonspeculative case at lines 36 through 38.

Table 3 shows pseudocode for the abort handler in this embodiment, that operates in the context of transactional memory related events generated during transactions begun by the speculative transaction code from Table 2. The transactional memory hardware architecture transfers control to this handler when an event related to transactional memory that would need the attention of this handler has occurred. In general, as discussed earlier, the event may be an exhaustion of the hardware resources allocated to supporting speculative execution or transactional memory resources in general; a data consistency error caused by a conflicting access by a different thread to a memory location to which this process has written or from which this process has read speculatively; or some other external error condition relating to transactional memory. The pseudocode in Table 3 corresponds generally to blocks 270-290 in FIG. 2. The handler in Table 3 first determines, at line 3, whether the interrupt that transferred control to the handler was generated by hardware resource exhaustion or by another kind of error. If the event was caused by an error relating to the correctness of the speculative execution, such as a data consistency error, the test at line 3 is true and the handler aborts and rolls back the speculative execution at line 4 by aborting the transaction that was begun earlier. Otherwise, the speculative execution is successful, but now the handler needs to wait on the other threads to complete because it can no longer operate speculatively, as there are insufficient resources for further speculation. To achieve this, the handler recovers the references to the barrier and the epoch at lines 6 and 7 respectively, and then uses these to wait in the spin lock loop at line 8 until all the other threads are done. Once all threads have reached the barrier, the handler at line 9 then commits the transaction that this thread began, and all changes made speculatively are now effective and become visible atomically.

As should be clear to one in the art, the tables above are merely exemplary code fragments in one embodiment. In other embodiments, the implementation language may be another language, e.g. C or Java; the variable names used may vary, and the names of all the functions defined or called may vary. Structure and logic of programs to accomplish the functions accomplished by the programs listed above may be arbitrarily varied, without changing the input and output relationship, as is known.

In the preceding description, for purposes of explanation, numerous specific details are set forth in order to provide a thorough understanding of the described embodiments, however, one skilled in the art will appreciate that many other embodiments may be practiced without these specific details.

Some portions of the detailed description above are presented in terms of algorithms and symbolic representations of operations on data bits within a processor-based system. These algorithmic descriptions and representations are the means used by those skilled in the art to most effectively convey the substance of their work to others in the art. The operations are those requiring physical manipulations of physical quantities. These quantities may take the form of electrical, magnetic, optical or other physical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the description, terms such as “executing” or “processing” or “computing” or “calculating” or “determining” or the like, may refer to the action and processes of a processor-based system, or similar electronic computing device, that manipulates and transforms data represented as physical quantities within the processor-based system's storage into other data similarly represented or other such information storage, transmission or display devices.

In the description of the embodiments, reference may be made to accompanying drawings. In the drawings, like numerals describe substantially similar components throughout the several views. Other embodiments may be utilized and structural, logical, and electrical changes may be made. Moreover, it is to be understood that the various embodiments, although different, are not necessarily mutually exclusive. For example, a particular feature, structure, or characteristic described in one embodiment may be included within other embodiments.

Further, a design of an embodiment that is implemented in a processor may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, data representing a hardware model may be the data specifying the presence or absence of various features on different mask layers for masks used to produce the integrated circuit. In any representation of the design, the data may be stored in any form of a machine-readable medium. An optical or electrical wave modulated or otherwise generated to transmit such information, a memory, or a magnetic or optical storage such as a disc may be the machine readable medium. Any of these mediums may “carry” or “indicate” the design or software information. When an electrical carrier wave indicating or carrying the code or design is transmitted, to the extent that copying, buffering, or re-transmission of the electrical signal is performed, a new copy is made. Thus, a communication provider or a network provider may make copies of an article (a carrier wave) that constitute or represent an embodiment.

Embodiments may be provided as a program product that may include a machine-readable medium having stored thereon data which when accessed by a machine may cause the machine to perform a process according to the claimed subject matter. The machine-readable medium may include, but is not limited to, floppy diskettes, optical disks, DVD-ROM disks, DVD-RAM disks, DVD-RW disks, DVD+RW disks, CD-R disks, CD-RW disks, CD-ROM disks, and magneto-optical disks, ROMs, RAMs, EPROMs, EEPROMs, magnet or optical cards, flash memory, or other type of media machine-readable medium suitable for storing electronic instructions. Moreover, embodiments may also be downloaded as a program product, wherein the program may be transferred from a remote data source to a requesting device by way of data signals embodied in a carrier wave or other propagation medium via a communication link (e.g., a modem or network connection).

Many of the methods are described in their most basic form but steps can be added to or deleted from any of the methods and information can be added or subtracted from any of the described messages without departing from the basic scope of the claimed subject matter. It will be apparent to those skilled in the art that many further modifications and adaptations can be made. The particular embodiments are not provided to limit the claimed subject matter but to illustrate it. The scope of the claimed subject matter is not to be determined by the specific examples provided above but only by the claims below.

What is claimed is:

1. In a multi-threaded program, a method comprising:
a thread, of a set of threads sharing a synchronization barrier, indicating that the thread has reached the synchronization barrier to each other thread of the set of threads;
the thread beginning a transactional memory based transaction after the indicating; and
the thread continuing execution past the synchronization barrier after beginning the transactional memory based transaction.

2. The method of claim 1 further comprising:
if the thread has received an indication from every other thread of the set that those threads have reached the synchronization barrier and if the execution past the synchronization barrier has caused no data consistency errors, the thread committing the transactional memory based transaction.

3. The method of claim 2 further comprising:
the thread aborting the transaction and rolling back the execution past the synchronization barrier if the execution past the synchronization barrier has caused a data consistency error.

4. The method of claim 1, wherein indicating that the thread has reached the synchronization barrier to each other thread of the set of threads further comprises updating a barrier variable.

5. The method of claim 3 wherein, the thread checking whether the thread has received an indication from each other thread of the set that those threads have reached the synchronization barrier, further comprises the thread checking the barrier variable.

6. The method of claim 1, wherein the multithreaded program is a Java program.

7. The method of claim 2, wherein the multithreaded program is a Java program.

8. The method of claim 1, wherein the multithreaded program is a pthreads program.

9. The method of claim 2, wherein the multithreaded program is a pthreads program.

10. A machine readable medium having stored thereon a data that when accessed by a machine causes the machine to perform a method, in a multi-threaded program, comprising:
a thread, of a set of threads sharing a synchronization barrier, indicating that the thread has reached the synchronization barrier to each other thread of the set of threads;
the thread beginning a transactional memory based transaction after the indicating; and
the thread continuing execution past the synchronization barrier after beginning the transactional memory based transaction.

11. The machine readable medium of claim 10 wherein the method further comprises:
if the thread has received an indication from every other thread of the set that they have reached the synchronization barrier and if the execution past the synchronization barrier has caused no data consistency errors, the thread committing the transactional memory based transaction.

12. The machine readable medium of claim 11 wherein the method further comprises the thread aborting the transaction and rolling back the execution past the synchronization barrier if execution past the synchronization barrier has caused a data consistency error.

13. The machine readable medium of claim 10, wherein indicating that the thread has reached the synchronization barrier to each other thread of the set of threads further comprises updating a barrier variable.

14. The machine readable medium of claim 12 wherein, the thread checking whether it has received an indication from each other thread of the set that it has reached the synchronization barrier, further comprises the thread checking the barrier variable.

15. The machine readable medium of claim 10, wherein the multithreaded program is a Java program.

16. The machine readable medium of claim 11, wherein the multithreaded program is a Java program.

17. The machine readable medium of claim 10, wherein the multithreaded program is a pthreads program.

18. The machine readable medium of claim 11, wherein the multithreaded program is a pthreads program.

19. A system comprising a transactional memory architecture comprising:
a processor to execute programs, and further operable to
initiate a transactional memory based transaction;
commit a transactional memory based transaction; and
abort a transactional memory based transaction;
a memory;
a transactional memory architecture;
the processor to execute a thread, of a set of threads stored in the memory sharing a synchronization barrier, the thread
to indicate that the thread has reached the synchronization barrier to each other thread of the set of threads;
to initiate a transactional memory based transaction after the indicating; and
to continue execution past the synchronization barrier after beginning the transactional memory based transaction.

20. The system of claim 19 wherein:
if the thread has received an indication from every other thread of the set that it has reached the synchronization barrier and if the execution past the synchronization barrier has caused no data consistency errors, the thread is further to commit the transactional memory based transaction.

21. The system of claim 20 wherein the thread is further to abort the transaction and roll back the execution past the synchronization barrier if execution past the synchronization barrier has caused a data consistency errors.

22. The system of claim 19, wherein the memory further comprises DRAM.
